(19) United States
(12) Patent Application Publication
(10) Pub. No.: US 2016/0014812 A1
(43) Pub. Date: Jan. 14, 2016

(54) METHOD AND APPARATUS FOR TRANSMITTING CONTROL INFORMATION IN D2D NETWORK

(71) Applicant: Electronics and Telecommunications Research Institute, Daejeon (KR)

(72) Inventors: Ok-Sun PARK, Daejeon (KR); Ji Hyung KIM, Daejeon (KR); Seung Chan BANG, Daejeon (KR); Moon-Sik LEE, Daejeon (KR)

(21) Appl. No.: 14/796,603

(22) Filed: Jul. 10, 2015

(30) Foreign Application Priority Data
Jul. 11, 2014 (KR) 10-2014-0087792
Jul. 8, 2015 (KR) 10-2015-0097229

(51) Int. Cl. H04W 74/00; H04L 5/00; H04W 76/02

(52) U.S. Cl. CPC H04W 74/006; H04W 76/023; H04L 5/0048

(57) ABSTRACT

A method of sending control information including selecting an available physical resource block (PRB) in a control subframe included in a D2D frame and sending the control information using the available PRB, and a terminal for realizing the method, are provided.

### CROSS-REFERENCE TO RELATED APPLICATION

This application claims priority to and the benefit of Korean Patent Application Nos. 10-2014-0087792 and 10-2015-0097229 filed in the Korean Intellectual Property Office on Jul. 11, 2014 and Jul. 8, 2015, the entire contents of which are incorporated herein by reference.

### BACKGROUND OF THE INVENTION

(a) Field of the Invention

The present invention relates to a method and terminal for transmitting control information in a device-to-device (D2D) direct communication network.

(b) Description of the Related Art

In 3GPP, the standardization of physical channels and signals for a device-to-device (D2D) proximity service in an LTE network is in progress. A D2D data physical channel for a D2D proximity service may send D2D data and control information. Resource allocation in the D2D data physical channel includes two methods. A first method “mode 1” is a method of allocating, by a base station, the resources of D2D data physical channels for sending control information and data and signaling the allocated resources. A second method “mode 2” is a method of autonomously selecting, by a terminal, the resources of D2D data physical channels without control of a network, and does not require signaling.

Scheduling allocation (SA), that is, resource allocation information determined to be either one of mode 1 and mode 2, needs to be transmitted before a D2D data physical channel is transmitted. If SA information about a D2D data channel is transmitted in accordance with the mode 2 method, a D2D terminal may determine the SA information using a method of sensing available resources in a predetermined resource pool in a specific time interval or a method of randomly selecting available resources.

In the method of sensing available resources by a terminal in a predetermined resource pool, a conventional terminal detects energy in a channel, compares the detected energy with a predetermined threshold value, and determines the available state of the channel. However, sensing a channel based on the detection of energy is disadvantageous in that accuracy is low if line of sight (LOS) between terminals is not guaranteed.

### SUMMARY OF THE INVENTION

The present invention has been made in an effort to provide a method and apparatus for sensing, by a D2D terminal, a channel based on a metric calculated through the comparison of a reference signal, selecting the radio resources of a D2D physical channel, and sending control information.

An exemplary embodiment of the present invention provides a method of transmitting control information by a terminal performing device-to-device (D2D) communication. The transmitting method include: selecting an available physical resource block (PRB) in a control subframe included in a D2D frame and sending the control information using the available PRB.

The selecting the PRB may include: randomly selecting a first PRB in the control subframe; and determining whether the first PRB is the available PRB based on a reference signal (RS) received in the first PRB.

The determining whether the first PRB is the available PRB may include: determining whether a signal has been detected in the first PRB based on the received RS and the known RS sequence; and determining the first PRB to be the available PRB if it is determined that a signal has not been detected in the first PRB.

The transmitting method may further include: randomly selecting a second PRB in a control subframe next to the control subframe if it is determined that a signal has been detected in the first PRB; and determining whether the second PRB is the available PRB based on an RS received in the second PRB.

The determining whether a signal has been detected in the first PRB may include: calculating a decision metric based on a correlation between the received RS and the known RS sequence; and determining that a signal has been detected in the first PRB if the decision metric is equal to or greater than a threshold value and determining that a signal has not been detected in the first PRB if the decision metric is smaller than a threshold value.

The decision metric may be a ratio between a maximum value of the correlation and a normalized average value of the correlation.

The control subframe may be repeated at an interval of a scheduling allocation (SA) period in the D2D frame.

The transmitting method may further include sensing the available PRB using a predetermined sensing period as a period.

The transmitting method may further include sensing the available PRB in a control subframe included in a predetermined sensing period.

The size of the available PRB may be 2.

Another exemplary embodiment of the present invention provides a terminal performing device-to-device (D2D) communication. The terminal includes: at least one processor; a memory; and a radio frequency (RF) unit, wherein the at least one processor selects an available physical resource block (PRB) in a control subframe included in a D2D frame and sends the control information using the available PRB by executing at least one program stored in the memory.

When selecting the PRB, the at least one processor randomly may select a first PRB in the control subframe and may determine whether the first PRB is the available PRB based on a reference signal (RS) received in the first PRB.

When determining whether the first PRB is the available PRB, the at least one processor may determine whether a signal has been detected in the first PRB based on the received RS and an RS sequence and may determine the first PRB to be the available PRB if it is determined that a signal has not been detected in the first PRB.

The at least one processor randomly may select a second PRB in a control subframe next to the control subframe if it is determined that a signal has been detected in the first PRB and may determine whether the second PRB is the available PRB based on an RS received in the second PRB by executing the at least one program.

When determining whether a signal has been detected in the first PRB, the at least one processor may calculate a decision metric based on a correlation between the received RS and the known RS sequence, and may determine that a signal has been detected in the first PRB if the decision metric is equal to or greater than a threshold value and may determine that a signal has not been detected in the first PRB if the decision metric is smaller than a threshold value.

The decision metric may be a ratio between a maximum value of the correlation and a normalized average value of the correlation.

The control subframe may be repeated at an interval of a scheduling allocation (SA) period in the D2D frame.

The at least one processor may sense the available PRB using a predetermined sensing period as a period by executing the at least one program.

The at least one processor may sense the available PRB in a control subframe included in a predetermined sensing period by executing the at least one program.

The size of the available PRB may be 2.

### BRIEF DESCRIPTION OF THE DRAWINGS

FIG. 1 is a diagram illustrating a D2D frame in accordance with an exemplary embodiment of the present invention.

FIG. 2 is a diagram illustrating a control subframe in accordance with an exemplary embodiment of the present invention.

FIG. 3 is a diagram illustrating the sensing interval of a D2D terminal in accordance with an exemplary embodiment of the present invention.

FIG. 4 is a flowchart illustrating a PRB selection method in accordance with an exemplary embodiment of the present invention.

FIG. 5 is a flowchart illustrating a PRB selection method in accordance with another embodiment of the present invention.

FIG. 6 is a graph illustrating missing probability and false alarm probability of a DMRS sequence in accordance with an exemplary embodiment of the present invention.

FIG. 7 is a graph illustrating the missing probability and false alarm probability of a DMRS sequence in accordance with another embodiment of the present invention.

FIG. 8 is a block diagram illustrating a wireless communication system in accordance with another embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a mobile station (MS) may refer to a terminal, a mobile terminal (MT), an advanced mobile station (AMS), a high reliability mobile station (HR-MS), a subscriber station (SS), a portable subscriber station (PSS), an access terminal (AT), or user equipment (UE), and may include some or all of the functions of the MT, MS, AMS, HR-MS, SS, PSS, AT, and UE.

Furthermore, a base station (BS) may refer to an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) functioning as a base station, a relay node (RN) functioning as a base station, an advanced relay station (ARS) functioning as a base station, a high reliability relay station (HR-RS) functioning as a base station, or a small base station [e.g., a femto BS, a home node B (HNB), a home eNodeB (HeNB), a pico BS, a metro BS, or a micro BS], and may include some or all of the functions of the ABS, nodeB, eNodeB, AP, RAS, BTS, MMR-BS, RS, RN, ARS, HR-RS, and small base station.

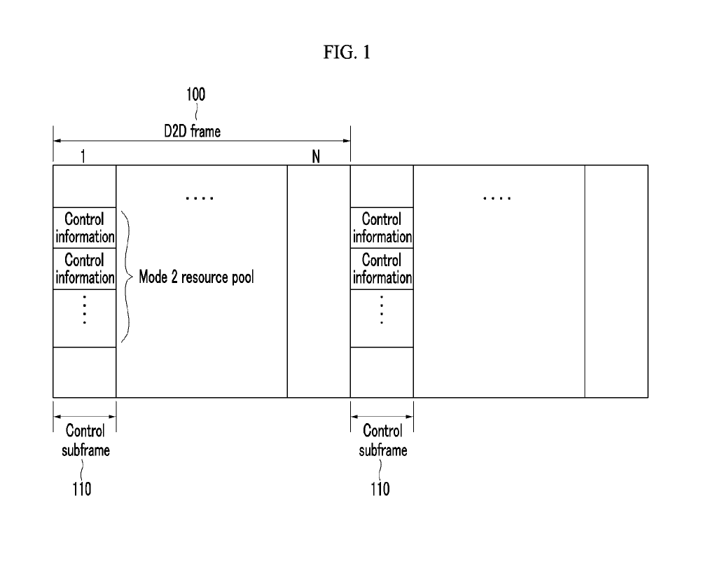

FIG. 1 is a diagram illustrating a D2D frame in accordance with an exemplary embodiment of the present invention.

Referring to FIG. 1, the D2D frame 100 in accordance with an exemplary embodiment of the present invention includes N subframes. The first subframe of the N subframes is a control subframe 110. Subcarriers and symbols included in the control subframe 110 may be the same as subcarriers and symbols of a physical uplink shared channel (PUSCH) in 3GPP LTE. Furthermore, control information for D2D data transmission (i.e., D2D control information) may be transmitted in the control subframe 110. Some of a plurality of PRBs included in the control subframe 110 are allocated for the transmission of D2D control information. In this case, the PRBs for transmitting D2D control information may be divided into a mode 1 resource pool and a mode 2 resource pool. A base station in accordance with an exemplary embodiment of the present invention may broadcast system information including information about the mode 1 resource pool and the mode 2 resource pool (e.g., the location of all available time resources and the locations of PRBs used in mode 1 and mode 2).

In accordance with an exemplary embodiment of the present invention, the length of control information may be fixed to a specific length. The control information may include information about the time when D2D data is transmitted, the location of frequency resources, and a modulation method. In this case, a fixed method may be used as a modulation method and channel coding scheme for a D2D data physical channel in which the control information is transmitted. In this case, a reception terminal may perform blind decoding without separate information other than information about the mode 2 resource pool.

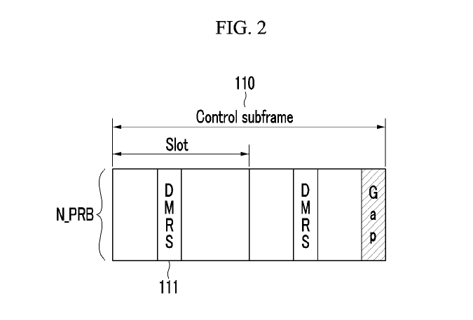

FIG. 2 is a diagram illustrating a control subframe in accordance with an exemplary embodiment of the present invention.

Referring to FIG. 2, the size (N PRBs) of the resources of a physical channel in which control information is transmitted in one control subframe 110 is fixed. Furthermore, a demodulation reference signal (DMRS) 111 may be transmitted in one symbol per slot within the control subframe 110. In accordance with an exemplary embodiment of the present invention, the DMRS 111 may be generated in a same way of generating a DMRS for a PUSCH in 3GPP LTE. In this case, terminals synchronized from the same synchronization source may use the same DMRS sequence in the control subframe 110, and a cyclic shift and orthogonal cover code may be fixed.

When a D2D terminal in accordance with an exemplary embodiment of the present invention autonomously selects PRBs, the D2D terminal may randomly select the PRBs in the mode 2 resource pool of the control subframe 110, may perform sensing during a predetermined time through the selected PRBs, and may then determine a PRB through which control information will be transmitted based on a result of the sensing.

The D2D terminal in accordance with an exemplary embodiment of the present invention may extract a DMRS from a signal received in each slot of the control subframe 110, and may calculate a decision metric based on a correlation between the extracted DMRS and the known DMRS sequence. The decision metric may be defined as a ratio between a maximum value of the correlation and a normalized average value of the correlation. For example, if the decision metric is equal to or greater than a threshold value, the D2D terminal may determine that a signal has been detected. If the decision metric is smaller than the threshold value, the D2D terminal may determine that a signal has not been detected. The D2D terminal may measure the correlation using the DMRS 111 received in a selected PRB of the control subframe 110. Thereafter, if the calculated decision metric is equal to or greater than the threshold value based on the measured correlation, the D2D terminal may determine that a signal has been detected. In order to select an empty PRB, the D2D terminal may randomly select a PRB at another location of the control subframe 110 and calculate a decision metric according to the correlation of a DMRS. That is, the D2D terminal in accordance with an exemplary embodiment of the present invention may randomly select a PRB in the mode 2 resource pool, may sense a signal in the selected PRB, and may determine whether the selected PRB is available through the calculation of a decision metric. Thereafter, a transmission D2D terminal sends control information including the location of a data transmission resource through an available PRB.

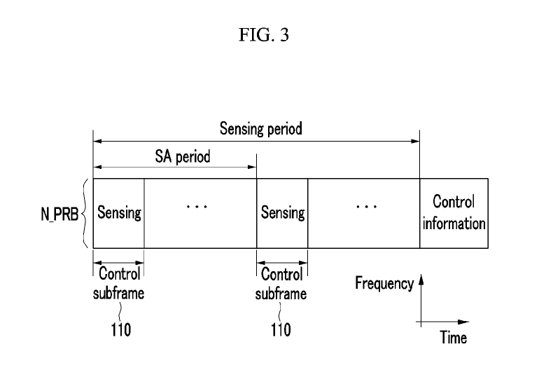

FIG. 3 is a diagram illustrating the sensing interval of a D2D terminal in accordance with an exemplary embodiment of the present invention.

In the D2D frame 100 in accordance with an exemplary embodiment of the present invention, the cycle in which the control subframe 110 is repeated is an SA period, and a time period in which the D2D terminal performs sensing is a sensing period. The D2D terminal performs sensing within each of the control subframes 110 included in the sensing period (the number of control subframes included in the sensing period is Nₛₑₙₛₑ).

Referring to FIG. 3, two control subframes 110 are included in one sensing period (Nₛₑₙₛₑ=2). In this case, the number of control subframes 110 on which sensing is performed (i.e., the number of control subframes Nₛₑₙₛₑ included in the sensing period) or the length of the sensing period may be determined depending on the requirements of a D2D proximity service. In a terminal placed out of the coverage of a base station, the sensing period may be pre-configured. A terminal placed at the edge of the coverage of a base station may receive information about a sensing period from a base station (i.e., semi-statically configured). If it is determined that a PRB within the control subframe 110 that is randomly selected during a sensing period is not used, the D2D terminal in accordance with an exemplary embodiment of the present invention may send control information using a PRB of a next control subframe 110.

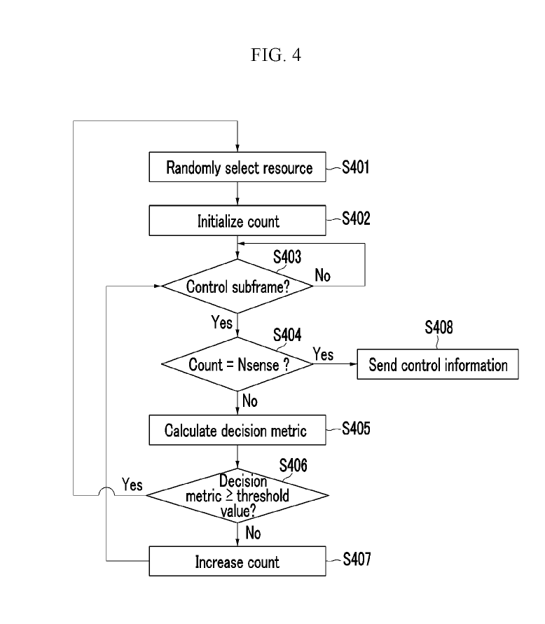

FIG. 4 is a flowchart illustrating a PRB selection method in accordance with an exemplary embodiment of the present invention.

First, when a request for transmitting D2D data is generated, a D2D terminal randomly selects PRBs in the mode 2 resource pool at step S401. Furthermore, a count “cnt” is initialized to 0 at step S402. The count is for measuring the number of sensing operations performed by the D2D terminal in the control subframe 110.

Furthermore, the D2D terminal determines whether the count has reached the number of control subframes Nₛₑₙₛₑ in the control subframe 110 at step S403 and at step S404. In this case, the D2D terminal in accordance with an exemplary embodiment of the present invention does not perform a procedure if a subframe is not the control subframe 110 because a decision metric can be calculated only in the control subframe 110.

If it is determined that the count has not reached the number of control subframes Nₛₑₙₛₑ, the D2D terminal checks a correlation between a received signal and a DMRS in the PRB of a selected location, and calculates a decision metric at step S405. That is, the D2D terminal may determine whether the count has reached the number of control subframes Nₛₑₙₛₑ and may use a randomly selected PRB if the randomly selected PRB is empty for a specific time. Accordingly, a collision probability can be reduced.

The D2D terminal compares the calculated decision metric with a threshold value at step S406. If the decision metric is found to be smaller than the threshold value, the D2D terminal increases the count at step S407 and determines whether the count has reached the number of control subframes Nₛₑₙₛₑ in the control subframe 110 again.

If it is determined that the count has reached the number of control subframes Nₛₑₙₛₑ (i.e., cnt=Nₛₑₙₛₑ), the D2D terminal sends control information (e.g., SA) in the PRB of the selected location at step S408. Thereafter, the D2D terminal may send data through resources related to SA.

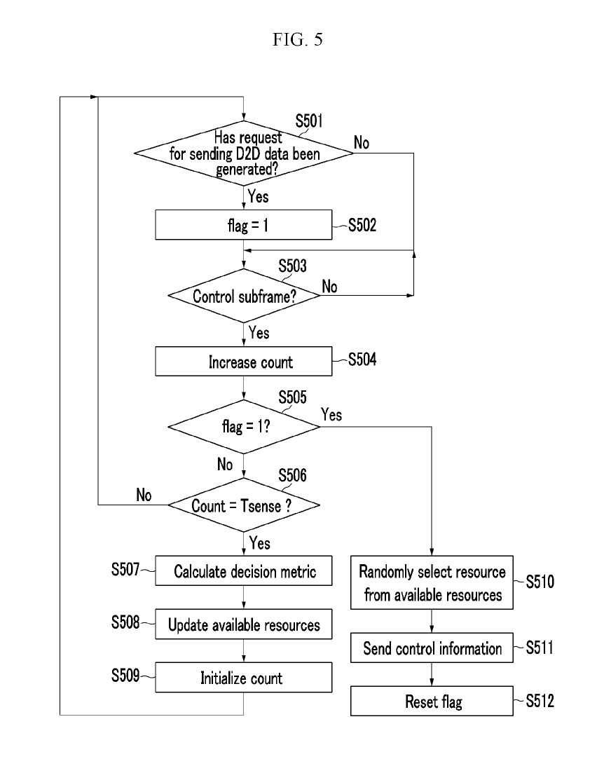

FIG. 5 is a flowchart illustrating a PRB selection method in accordance with another embodiment of the present invention.

First, a D2D terminal determines whether a request for transmitting D2D data has occurred at step S501, and sets a flag (e.g., flag=1) if it is determined that the request for transmitting D2D data has occurred at step S502. A D2D terminal in accordance with another embodiment of the present invention may secure available resources through the calculation of a decision metric if it is determined that a request for transmitting D2D data has not occurred. Thereafter, when a request for transmitting D2D data is generated, the D2D terminal may randomly select resources from the available resources and send control information. In this case, the flag may be used to identify a case where the request for transmitting D2D data has occurred.

Furthermore, the D2D terminal checks whether a subframe is the control subframe 110 at step S503. A D2D terminal in accordance with another embodiment of the present invention does not perform a procedure if a subframe is found to not be the control subframe 110 because it calculates a decision metric only in the control subframe 110.

Thereafter, the D2D terminal increases the count in the control subframe 110 of the D2D frame 100 at step S504, and checks whether the flag has been set at step S505. If the flag is found to have not been set, the D2D terminal determines whether the count has reached Tₛₑₙₛₑ at step S506. If it is determined that the count has not reached Tₛₑₙₛₑ, the D2D terminal returns to the step of determining whether a request for transmitting D2D data has occurred. If it is determined that the count has reached Tₛₑₙₛₑ, the D2D terminal calculates a decision metric with respect to all PRBs included in the mode 2 resource pool in order to secure available resources, at step S507. In this case, the decision metric may be calculated based on a correlation between a DMRS of a received signal and a DMRS sequence. Furthermore, the D2D terminal updates available PRBs based on the decision metric at step S508. Furthermore, the count is initialized (i.e., cnt=0) at step S509.

If the flag is found to have been set at step S505, the D2D terminal randomly selects at least one PRB of the available PRBs updated based on the decision metric at step S510, and sends control information through the selected PRB at step S511. Furthermore, the flag is initialized (i.e., flag=0) at step S512.

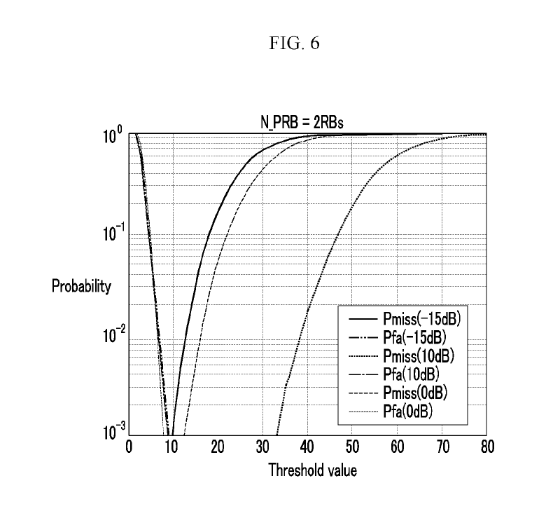

FIG. 6 is a graph illustrating the missing probability and false alarm probability of a DMRS sequence in accordance with an exemplary embodiment of the present invention.

A D2D terminal in accordance with an exemplary embodiment of the present invention may determine a threshold value based on the missing probability Pₘᵢₛₛ and false alarm probability P_{fa} of a DMRS sequence. The missing probability is a probability that a DMRS transmitted by another D2D terminal is not detected through the PRBs of the mode 2 resource pool. The false alarm probability is a probability that a DMRS is erroneously detected to have been transmitted although the DMRS has not been transmitted through a PRB of the mode 2 resource pool.

FIG. 6 illustrates the missing probability and false alarm probability of a DMRS according to a threshold value if the size of a PRB for SA is 2 (i.e., N_PRB=2 PRBs). In accordance with an exemplary embodiment of the present invention, a channel environment was assumed to be an additive white Gaussian noise (AWGN) channel, and accurate synchronization between D2D terminals was assumed. Referring to FIG. 6, if the threshold value was 9, both the missing probability and the false alarm probability Pₘᵢₛₛ and P_{fa} were less than 0.1% regardless of a signal-to-noise ratio (SNR). That is, a threshold value at which both the missing probability and the false alarm probability can be minimized even in an environment in which the SNR is very low may be determined.

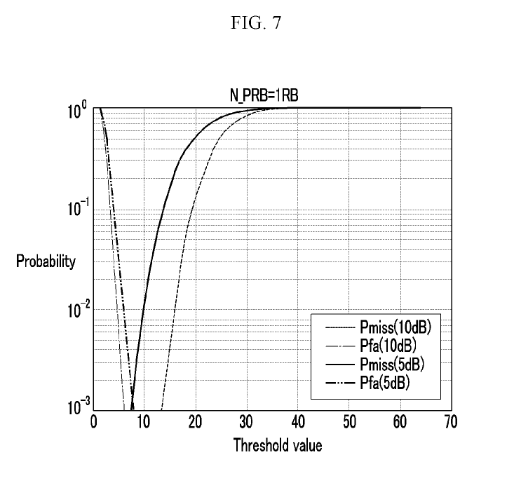

FIG. 7 is a graph illustrating the missing probability and false alarm probability of a DMRS sequence in accordance with another embodiment of the present invention.

FIG. 7 illustrates the missing probability and false alarm probability of a DMRS according to a threshold value if the size of a PRB for SA is 1 (i.e., N_PRB=1 PRB). Referring to FIG. 7, if the SNR is 5 dB or less (i.e., SNR≦5 dB), there is no threshold value at which both the missing probability and the false alarm probability Pₘᵢₛₛ and P_{fa} may become less than 0.1%. Accordingly, the size of the PRB of a D2D data physical channel in which control information (e.g., SA) is transmitted may be determined to be 2.

As described above, in accordance with an embodiment of the present invention, a D2D terminal can efficiently select radio resources so that a collision in the transmission of control information can be reduced out of the coverage of a base station.

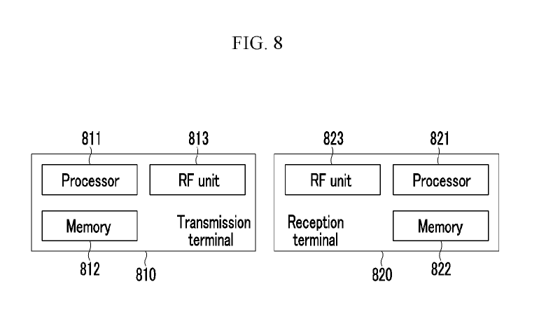

FIG. 8 is a block diagram illustrating a wireless communication system in accordance with another embodiment of the present invention.

Referring to FIG. 8, a wireless communication system in accordance with an exemplary embodiment of the present invention includes a transmission terminal 810 and a reception terminal 820.

The transmission terminal 810 includes a processor 811, a memory 812, and a radio frequency (RF) unit 813. The memory 812 is connected to the processor 811, and may store various information for driving the processor 811. The RF unit 813 is connected to the processor 811, and may send and receive radio signals. The processor 811 may implement the functions, processes, or methods proposed in accordance with an exemplary embodiment of the present invention. In this case, in a wireless communication system in accordance with an exemplary embodiment of the present invention, the layers of a radio interface protocol may be implemented by the processor 811. The operation of the transmission terminal 810 in accordance with an exemplary embodiment of the present invention may be implemented by the processor 811.

The reception terminal 820 includes a processor 821, a memory 822, and an RF unit 823. The memory 822 is connected to the processor 821, and may store various information for driving the processor 821. The RF unit 823 is connected to the processor 821, and may send and receive radio signals. The processor 821 may implement the functions, processes, or methods proposed in accordance with an exemplary embodiment of the present invention. In a wireless communication system in accordance with an exemplary embodiment of the present invention, the layers of a radio interface protocol may be implemented by the processor 821. The operation of the reception terminal 820 in accordance with an exemplary embodiment of the present invention may be implemented by the processor 821.

In accordance with an exemplary embodiment of the present invention, the memory may be placed inside or outside the processor, and may be connected to the processor through various known means. The memory may include a variety of types of volatile or non-volatile storage media, and may include read-only memory (ROM) or random access memory (RAM).

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting control information by a terminal performing device-to-device (D2D) communication, the method comprising:
selecting an available physical resource block (PRB) in a control subframe included in a D2D frame; and
sending the control information using the available PRB.

2. The method of claim 1, wherein selecting the PRB comprises:
randomly selecting a first PRB in the control subframe; and
determining whether the first PRB is the available PRB based on a reference signal (RS) received in the first PRB.

3. The method of claim 2, wherein determining whether the first PRB is the available PRB comprises:
determining whether a signal has been detected in the first PRB based on an RS sequence and the received RS; and
determining the first PRB to be the available PRB if it is determined that a signal has not been detected in the first PRB.

4. The method of claim 3, further comprising:
randomly selecting a second PRB in a control subframe next to the control subframe if it is determined that a signal has been detected in the first PRB; and
determining whether the second PRB is the available PRB based on an RS received in the second PRB.

5. The method of claim 3, wherein determining whether a signal has been detected in the first PRB comprises:
calculating a decision metric based on a correlation between the RS sequence and the received RS; and
determining that a signal has been detected in the first PRB if the decision metric is equal to or greater than a threshold value and determining that a signal has not been detected in the first PRB if the decision metric is smaller than a threshold value.

6. The method of claim 5, wherein the decision metric is a ratio between a maximum value of the correlation and a normalized average value of the correlation.

7. The method of claim 1, wherein the control subframe is repeated at an interval of a scheduling allocation (SA) period in the D2D frame.

8. The method of claim 1, further comprising sensing the available PRB using a predetermined sensing period as a period.

9. The method of claim 1, further comprising sensing the available PRB in a control subframe included in a predetermined sensing period.

10. The method of claim 1, wherein a size of the available PRB is 2.

11. A terminal performing device-to-device (D2D) communication, comprising:
at least one processor;
a memory; and
a radio frequency (RF) unit,
wherein the at least one processor selects an available physical resource block (PRB) in a control subframe included in a D2D frame and sends the control information using the available PRB by executing at least one program stored in the memory.

12. The terminal of claim 11, wherein when selecting the PRB, the at least one processor randomly selects a first PRB in the control subframe and determines whether the first PRB is the available PRB based on a reference signal (RS) received in the first PRB.

13. The terminal of claim 12, wherein when determining whether the first PRB is the available PRB, the at least one processor determines whether a signal has been detected in the first PRB based on an RS sequence and the received RS and determines the first PRB to be the available PRB if it is determined that a signal has not been detected in the first PRB.

14. The terminal of claim 13, wherein the at least one processor randomly selects a second PRB in a control subframe next to the control subframe if it is determined that a signal has been detected in the first PRB and determines whether the second PRB is the available PRB based on an RS received in the second PRB by executing the at least one program.

15. The terminal of claim 13, wherein when determining whether a signal has been detected in the first PRB, the at least one processor calculates a decision metric based on a correlation between the RS sequence and the received RS, and determines that a signal has been detected in the first PRB if the decision metric is equal to or greater than a threshold value and determines that a signal has not been detected in the first PRB if the decision metric is smaller than a threshold value.

16. The terminal of claim 15, wherein the decision metric is a ratio between a maximum value of the correlation and a normalized average value of the correlation.

17. The terminal of claim 11, wherein the control subframe is repeated at an interval of a scheduling allocation (SA) period in the D2D frame.

18. The terminal of claim 11, wherein the at least one processor senses the available PRB using a predetermined sensing period as a period by executing the at least one program.

19. The terminal of claim 11, wherein the at least one processor senses the available PRB in a control subframe included in a predetermined sensing period by executing the at least one program.

20. The terminal of claim 11, wherein a size of the available PRB is 2.
